(19) United States
(12) Patent Application Publication
(10) Pub. No.: US 2009/0156048 A1
(43) Pub. Date: Jun. 18, 2009

(54) Electrical Connector And Contact Insertion Guide

(76) Inventor: Hidetaka Homme, Tokyo (JP)

Correspondence Address: BARLEY SNYDER, LLC, 1000 WESTLAKES DRIVE, SUITE 275, BERWYN, PA, 19312, US

(21) Appl. No.: 12/338,727

(22) Filed: Dec. 18, 2008

(30) Foreign Application Priority Data
Dec. 18, 2007 (JP) 2007-326137

(51) Int. Cl. H01R 13/64; H01R 9/00

(52) U.S. Cl. 439/374; 439/722

(57) ABSTRACT

The invention relates to a contact insertion guide structure having a contact and an insulative housing. The contact having a mating portion for contacting a mating contact at one end, a terminal portion for connecting to a circuit board on an opposite end, and a press-fit section between the mating portion and the terminal portion. The housing having a contact receiving passageway through which the contact is inserted, and a securing section which is formed in an inner wall of the contact receiving passageway and into which the press-fit section is received. The contact further includes a first narrow section formed closer to the terminal portion than the press-fit section and thinner than the press-fit section, and a second narrow section formed closer to the terminal portion than the first narrow section and further thinner than the first narrow section. The housing further comprising a wide section that is formed in the contact receiving passageway at a more downstream side in a direction where the contact is inserted than a position where the securing section is formed. The wide section has a larger width than that of the first narrow section of the contact. The housing further including a contact support section that is formed in the contact receiving passageway at a more downstream side in the direction where the contact is inserted than a position where the wide section is formed, and the contact supporting section supporting the first narrow section of the contact.

### CROSS-REFERENCE TO RELATED APPLICATIONS

This is application claims the benefit of the filing date under 35 U.S.C. §119(a)-(d) of Japanese Patent Application No. 2007-326137, filed Dec. 21, 2007.

### FIELD OF THE INVENTION

The invention relates to a contact insertion guide structure and an electrical connector, and particularly relates to a contact insertion guide structure formed of terminals and an insulating housing, and an electrical connector using the contact insertion guide structure.

### BACKGROUND

Electrical connectors having a structure in which contacts are press-fit into an insulative housing, such as synthetic resin material, are readily known. Among such electrical connectors, some are mounted and soldered on a circuit board.

A V-type electrical connector mounted on a circuit board receives a mating connector perpendicular to the circuit board. In the V-type electrical connector, for example, terminals each have: a press-fit section secured in a through hole formed in a bottom wall of a concave section of the housing; a contact section that linearly extends in the housing from the press-fit section to contact a mating terminal; and a connection section that linearly extends substantially perpendicular to the circuit board for connection therewith. (for example, see Japanese Patent Application Publication No. 2006-4642).

An H-type electrical connector receives a mating connector parallel to the circuit board. In an H-type electrical connector, for example, there are terminals each having: a press-fit section secured in a through hole formed in a bottom wall of a housing; a contact section that linearly extends in the housing from the press-fit section to contact a mating terminal; an extend section that linearly extends outside of the insulating housing from the press-fit section; a bend section that continues to the extend section; and a connection section that extends downward from the bend section so as to be substantially perpendicular to a circuit board to which it is connected. (for example, see Japanese Patent Application Publication No. Hei 11-26058).

Here, during assembly of the V-type electrical connector and the H-type electrical connector, the terminal is generally inserted, in the housing, from the side of a connector interface with the mating connector. The terminal is press-fitted and fixed into the housing with the connection section, which is to be connected to the circuit board, projecting from the housing.

To mount the electrical connector, the connection sections of the terminals are inserted, by machine, into respective through holes of the circuit board. Here, when the terminals are not aligned in parallel with one another, a problem arises in which the connection sections of the terminals are not inserted into the respective through holes and the electrical connector cannot be mounted.

Moreover, in the electrical connector in which the plural terminals are press-fit into the housing, the connection sections of all the terminals need to be inserted into the through holes of the circuit board at one time when the electrical connector is mounted. For this reason, the electrical connector is generally provided with a terminal aligning plate (tine plate) having plural through holes formed thereon in order to align the connection sections of the terminals to be inserted into the through holes of the circuit board at predetermined positions. In this case, when the terminals are not aligned in parallel with one another, there arises a problem in that the connection sections are not inserted into the through holes of the tine plate when it is attached.

The problems are exasperated by longer length between the press-fit section and the connection section of each terminal, because such lengthening causes greater angular displacement of the connection section.

For example, in a case where the electrical connector is attached to an upper-layer circuit board of two circuit boards arranged in parallel with each other, the length between the press-fit section and the connection section of the terminal is necessarily increased, thus causing exasperation of the alignment problem.

### SUMMARY

It is an object of the present invention, among others, to provide a contact insertion guide structure and an electrical connector in which displacement of a connection section is suppressed with contacts press-fitted.

The invention relates to a contact insertion guide structure having a contact and an insulative housing. The contact having a mating portion for contacting a mating contact at one end, a terminal portion for connecting to a circuit board on an opposite end, and a press-fit section between the mating portion and the terminal portion. The housing having a contact receiving passageway through which the contact is inserted, and a securing section which is formed in an inner wall of the contact receiving passageway and into which the press-fit section is received. The contact further includes a first narrow section formed closer to the terminal portion than the press-fit section and thinner than the press-fit section, and a second narrow section formed closer to the terminal portion than the first narrow section and further thinner than the first narrow section. The housing further comprising a wide section that is formed in the contact receiving passageway at a more downstream side in a direction where the contact is inserted than a position where the securing section is formed. The wide section has a larger width than that of the first narrow section of the contact. The housing further including a contact support section that is formed in the contact receiving passageway at a more downstream side in the direction where the contact is inserted than a position where the wide section is formed, and the contact supporting section supporting the first narrow section of the contact.

### BRIEF DESCRIPTION OF THE DRAWINGS

The invention will be explained in greater detail in the following with reference to embodiments, referring to the appended drawings, in which:

FIG. 1 is an perspective view of a contact fitting insertion guide structure and an electrical connector according to a first embodiment of the present invention;

FIG. 2 is a longitudinal cross-sectional view of the electrical connector shown in FIG. 1;

FIG. 3 is an enlarged view of a state before a terminal is inserted into an insulating housing at a portion A illustrated in FIG. 2;

FIG. 4 is a partial cross-sectional view taken along a line 4-4 illustrated in FIG. 3;

FIG. 5 is a partial cross-sectional view illustrating a state where the terminal is further inserted from a first insertion state illustrated in FIG. 4;

FIG. 6 is a partial cross-sectional view illustrating a state where the terminal is further inserted from a second insertion state illustrated in FIG. 5;

FIG. 7 is a partial cross-sectional view illustrating a state where the terminal is further inserted from a third insertion state illustrated in FIG. 6, and thereby press-fitted;

FIG. 8 is a top view of a contact fitting insertion guide structure and an electrical connector according to a second embodiment of the present invention; and

FIG. 9 is a longitudinal cross-sectional view of the electrical connector illustrated in FIG. 8.

### DETAILED DESCRIPTION OF THE EMBODIMENT(S)

Embodiments of the present invention will be described below with reference to the drawings.

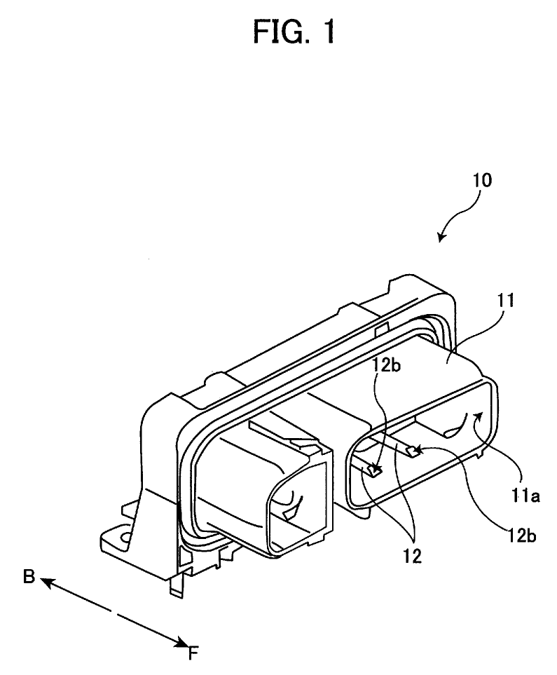

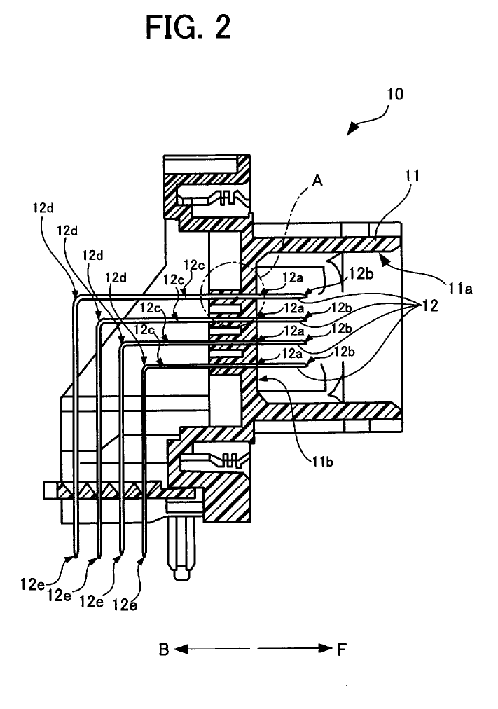

An H-type electrical connector 10, as illustrated in FIGS. 1 and 2, has an insulative housing 11 mountable on a circuit board and contacts 12 fixed in the housing 11. It should be noted that an illustration of the circuit board is omitted for clarity.

The housing 11 has, as illustrated in FIGS. 1 to 3, a connector receiving openings 11a, contact receiving passageways 11c, and securing sections 11d serving. Suitable insulative materials for the housing 11 may include but are not limited to synthetic resins, such as PBT, or syndiotactic polystyrene (SPS) which has high heat resistance.

A mating electrical connector is received in the connector receiving opening 11a. It should be noted that an illustration of the mating electrical connector is omitted for brevity and clarity.

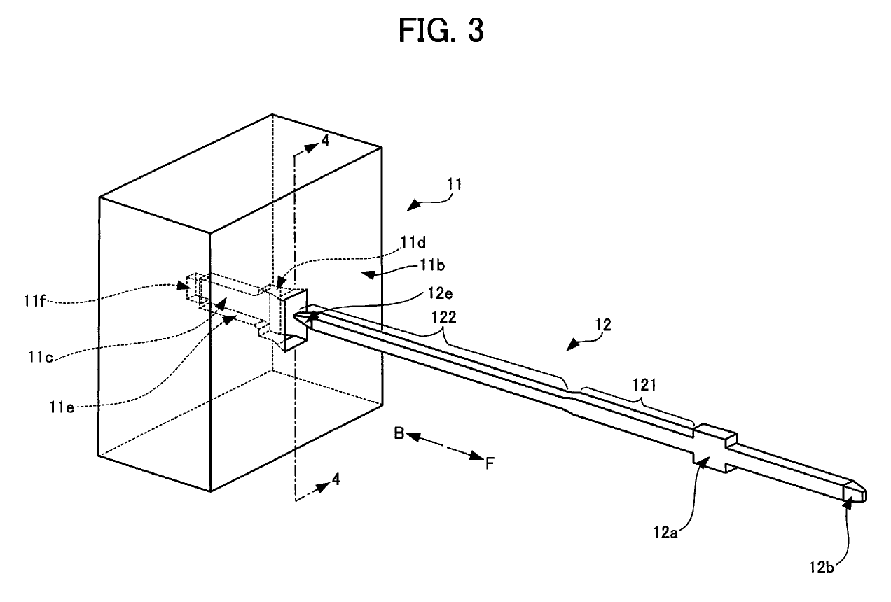

The contact receiving passageways 11c are formed in a contact securing wall 11b. The securing sections 11d are formed in an inner wall of the contact receiving passageways 11c so as to be larger than a terminal portion 12e of the contact 12. More specifically, the securing section 11d is formed to be wider in the upper and lower direction, as best shown in FIG. 3. Additionally, the securing section 11d is dimensioned to be slightly narrower than a press-fit section 12a of the contact 12.

As illustrated in FIG. 2, the contacts 12, arranged in four vertical rows, are secured to the housing 11 so as to be parallel with one another along the width of the connector 10.

The contacts 12 are stamped and formed or made from other suitable metal working processes. Each contact 12 includes a press-fit section 12a, a mating portion 12b, an intermediate section 12c, a bent section 12d and a terminal portion 12e as illustrated in FIGS. 1 to 3. The press-fit section 12a of the contact 12 has a generally rectangular shape projecting in a direction crossing an insertion direction of the contact 12, is press-fit and thereby secured into the contact receiving passageway 11c. The mating portion 12b projects from the press-fit section 12a of the contact 12 into the connector receiving opening 11a, and thus comes in contact with a mating contact (not shown).

The intermediate section 12c extends from the press-fit section 12a, outside of the connector receiving opening 11a projects backward in the direction indicated by B in the drawings. The bent section 12d extends to the intermediate section 12c. The terminal portion 12e extends downward from the bent section 12d so as to be substantially perpendicular to the circuit board. Each of the contact and terminal portions 12b, 12e have tapered ends.

Moreover, the contact 12 includes the first narrow section 121, which is formed closer to the terminal portion 12e than the press-fit section 12a and is thinner than the press-fit section 12a, and a second narrow section 122, which is formed closer to the terminal portion 12e than the first narrow section 121 and is further thinner than the first narrow section 121. The second narrow section 122 includes the bent section 12d. A taper serving as a guide is formed on each of the mating portion 12b and the terminal portion 12e. Further, a taper serving as a guide is also formed at a boundary part between the first narrow section 121 and the second narrow section 122.

It should be noted that, the contact 12 illustrated in FIG. 3 is shown in a state before the bent section 12d illustrated in FIG. 2 is formed. It is subsequently bent by a known method after the contact 12 is press-fit from the state illustrated in FIG. 3.

The securing section 11d has wide section 11e and contact support sections 11f, as illustrated in FIG. 3. Each wide section 11e is formed, in the inner wall of the contact receiving passageway 11c, proximate the securing section 11d. The wide section 11e is formed to be wider than the terminal portion 12e of the contact 12, and does not engage the contact 12. Each contact support section 11f is located proximate the wide section 11e and is formed to have substantially the same width as that of the terminal portion 12e. During contact 12 insertion, the contact support sections 11f comes in contact with the contact 12 in order to guide the contact 12. Further, the contact support sections 11f supports a portion between the terminal portion 12e and the press-fit section 12a of the contact 12, in a state where the press-fit section 12a of the contact 12 is press-fit to the securing sections 11d of the housing 11. The contact support sections 11f may be formed to be partially concaved in order to come in contact with the contact 12 over its periphery.

Moreover, an inclined surface serving as a guide is formed at a boundary part between the wide section 11e and the contact support sections 11f of the housing 11.

Hereinafter, descriptions will be provided for processes from a state before the contact 12 is fixed to the housing 11 to a state where the contact 12 is fixed to the housing 11.

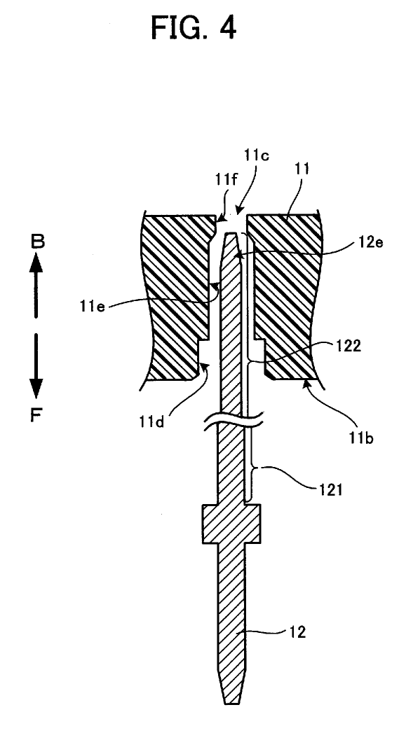

Insertion of the contact 12 into the housing 11 will now be described. FIG. 4 shows an initial step of an insertion process in which the terminal portion 12e of the contact 12 is inserted into the contact receiving passageways 11c on the forward F side. FIG. 4 illustrates a pre-insertion state.

As mentioned above, the wide section 11e and the securing sections 11d, which are formed ahead of the portion where the contact support sections 11f of the contact receiving passageway 11c is formed in the direction of the forward F, are formed to be wider than the first narrow section 121 of the contact 12, namely, wider than the second narrow section 122. Thus, the contact 12 does not come in contact with the inner wall of the contact receiving passways 11c in the first insertion state, as illustrated in FIG. 4.

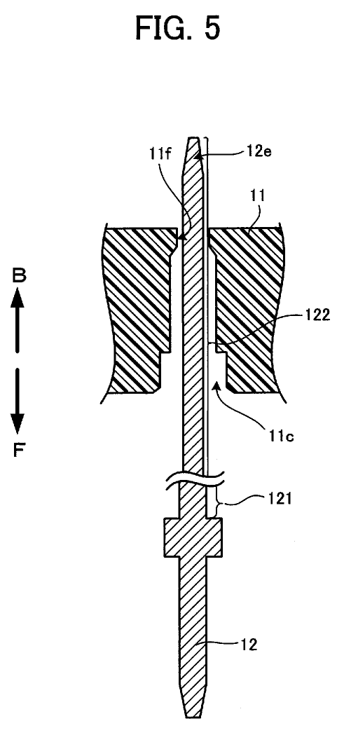

FIG. 5 is a partial cross-sectional view illustrating a state where the contact 12 is further inserted from the pre-insertion state illustrated in FIG. 4.

FIG. 5 illustrates a guide process in which the contact 12 is further inserted in the backward B direction from the pre-insertion state as illustrated in FIG. 4, to such an extent that the second narrow section 122 may be inserted into the contact support sections 11f.

As mentioned above, the contact support sections 11f, of the contact receiving passageways 11c is formed in such way as to have substantially the same width as that of the first narrow section 121 of the contact 12, namely, to be wider than the second narrow section 122. Thus, the contact 12 does not come in contact with the inner wall of the contact receiving passageway 11c in the second insertion state illustrated in FIG. 5.

Moreover, as mentioned above, the taper is formed on the mating portion 12b of the contact 12. Accordingly, insertion is performed smoothly, and when the contact 12 is inserted, buckling may be prevented.

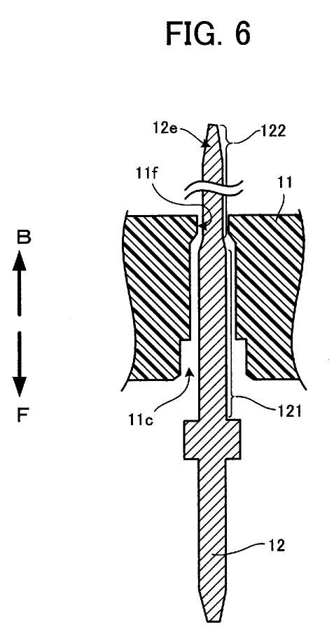

FIG. 6 is a partial cross-sectional view illustrating a state where the contact 12 is further inserted from the second insertion state illustrated in FIG. 5 and is thereby press-fit.

A third step in the insertion process is illustrated in FIG. 6, in which the contact 12 is further inserted from the second insertion state illustrated in FIG. 5 to such an extent that the contact 12 may be inserted just before the first narrow section 121 is supported by the contact support sections 11f.

Similar to the second insertion state, as illustrated in FIG. 5, the contact 12 does not come in contact with the inner wall of the contact receiving passageway 11c in the third insertion state, which is clearly illustrated in FIG. 6.

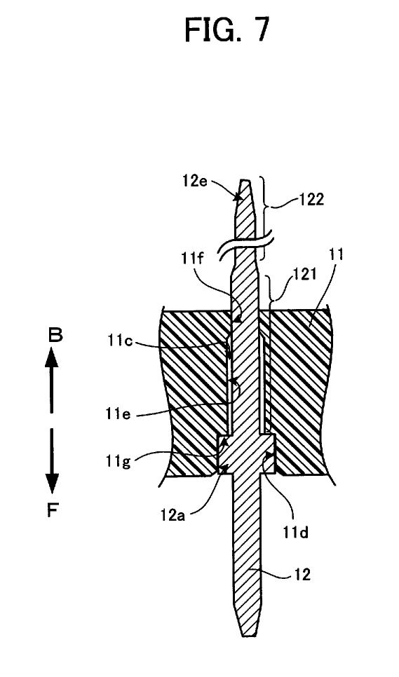

FIG. 7 is a partial cross-sectional view illustrating a state where the contact 12 is further inserted from a third insertion state illustrated in FIG. 6, and thereby press-fit.

A press-fitting process is illustrated in FIG. 6, in which the contact 12 is further inserted in the backward B direction from the third insertion state illustrated in FIG. 6 to such an extent that the contact 12 may be press-fitted into the housing 11.

As mentioned above, the securing sections 11d of the contact receiving passageways 11c of the housing 11 are formed to be slightly narrower than the press-fit sections 12a of the contacts 12. For this reason, when the press-fit sections 12a of the contact 12 is inserted, the securing sections 11d of the housing 11 are expanded. As a result, the contacts 12 are press-fitted and fixed into the housing 11.

Further, the first narrow section 121 of each contact 12 is supported by the contact support sections 11f in the press-fit completion state, as illustrated in FIG. 7.

Furthermore, a step section 11g is formed at a boundary part between the wide section 11e and the securing sections 11d of the contact receiving passageways 11c. The press-fit section 12a of the contact 12, which has a convex shape, contacts the step section 11g, thereby positioning it in the insertion direction, namely, forward and backward directions F and B. The guide process is therefore reliably performed.

Further, as mentioned above, the taper is formed at the boundary part located between the first narrow section 121 and the second narrow section 122 of the contact 12, and the inclined surface is formed at the boundary part between the wide section 11e and the contact support section 11f of the housing 11. Thereby, even when the terminal portion 12e is displaced at the time of shifting from the third insertion state to the press-fitting completion state, the insertion of the contact 12 is guided along the inclined surface, so that the displacement is smoothly corrected to prevent cracking and shaving of the boundary part located between the wide section 11e and the contact support sections 11f of the housing 11.

According to the contact insertion guide structure and the electrical connector 10 of the first embodiment, and even in the case of using the contact 12 where a portion, which extends outside of the connector receiving opening 11a of the housing 11 from the press-fit section 12a and is connected to a circuit board, is elongated, displacement of the terminal portion 12e is suppressed with the contact 12 press-fit. Hence, according to the contact insertion guide structure and the electrical connector 10 of the first embodiment, the terminal portion 12e of the contact 12 is smoothly inserted into the through hole of the circuit board when the contact 12 is mounted on the circuit board.

Moreover, according to the contact fitting insertion guide structure and the electrical connector 10 of the first embodiment, the housing 11 has the wide section 11e and the contact support sections 11f, and both of them are wider than the second narrow section 122 of the contact 12. Accordingly, when the contact 12 is inserted into the contact receiving passageways 11c from the side of the terminal portion 12e, the contact 12 does not come in contact with the inner wall of the contact receiving passageways 11c until the first narrow section 121 of the contact 12 is supported by the contact support sections 11f of the housing 11. This prevents the inner wall of the contact receiving passageways 11c from being shaved or cracked by the contact 12 when the contact 12 is inserted, and prevents resin waste thus shaved from being adhered to the contact 12.

Furthermore, according to the contact insertion guide structure and the electrical connector 10 of the first embodiment, the contact 12 is supported in two locations by the securing sections 11d and the contact support section 11f of the housing 11. Thus, when these two locations are molded with high precision, there is no need to precisely form the entire contact receiving passageways 11c.

A second embodiment of the present invention will now be described, and it should be noted that the first embodiment refers to an H-type electrical connector, while the second embodiment to be described below refers to a V-type electrical connector.

Hereinafter, the same components as those in the first embodiment are assigned the same reference numerals as those in the first embodiment and description thereof will be omitted, and only a difference from the first embodiment will be described.

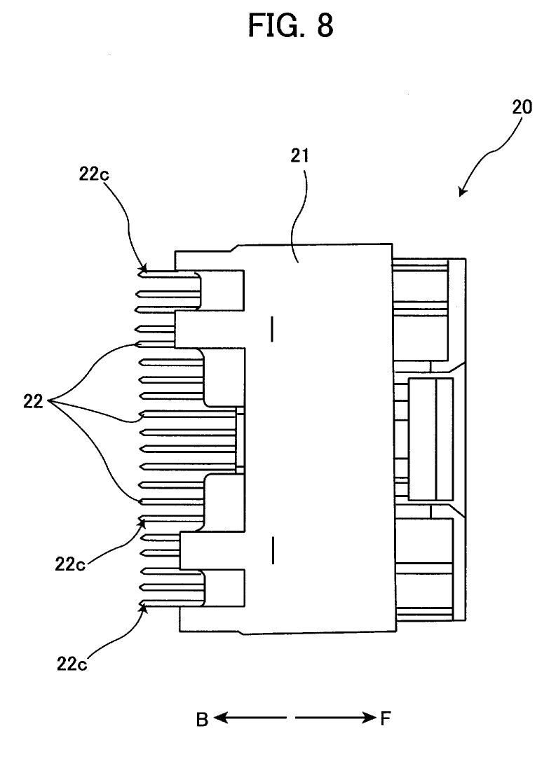

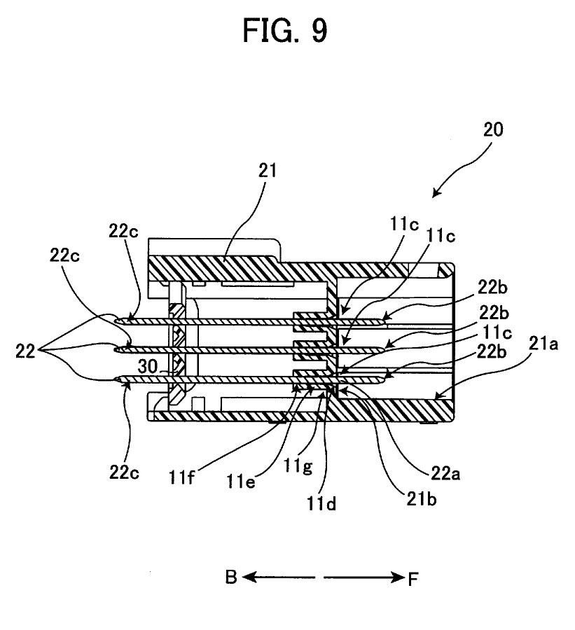

FIG. 8 is a top view of a contact insertion guide structure and an electrical connector 10 according to the third embodiment of the present invention viewed from the top, and FIG. 9 is a longitudinal cross-sectional view of the electrical connector 10 illustrated in FIG. 8.

An electrical connector 20 illustrated in FIGS. 8 and 9 is a so-called V-type electrical connector provided with an housing 21 to be fixed to a circuit board and multiple contacts 22 fixed to the housing 21. It should be noted that an illustration of the circuit board to which the housing 21 is to be fixed is omitted.

The housing 21 has, as illustrated in FIGS. 8 and 9, a mating connector receiving opening 21a, contact receiving passageways 11c, and securing sections 11d. A mating electrical connector is connected into the mating connector receiving opening 21a. It should be noted that an illustration of the mating electrical connector is omitted.

The contact receiving passageways 11c are formed in a contact support wall 21b of the mating connector receiving opening 21a. The securing sections 11d of the housing 21 are formed in an inner wall of the contact receiving passageways 11c. As illustrated in FIG. 9, the multiple contacts 22 are arranged in three vertical rows in a direction perpendicular to the sheet of FIG. 9, and are secured to the housing 21. Moreover, the housing 21 has the wide sections 11e, the contact support sections 11f, and the step sections 11g, similar to the housing 11 of the first embodiment. Further, an inclined surface serving as a guide is formed at a boundary part between the wide section 11e and the contact support section 11f of the housing 11.

The contacts 22 are plate-like members formed by stamping a metal plate, or other process. Each contact 22 includes a press-fit section 22a, a contact section 22b, and a connection section 22c as illustrated in FIGS. 8 and 9. The press-fit section 22a of the contact 22 has a convex shape projecting in a direction crossing an insertion direction of the contact 22, and is press-fit and thereby fixed into the contact receiving passageways 11c formed in the contact support wall 21b of the mating connector receiving opening 21a of the housing 21. The contact section 22b is a part that linearly extends from the press-fit section 22a of the contact 22 toward the mating connector receiving opening 21a of the housing 21, to project in the direction of the forward F from the contact support wall 21b of the mating connector receiving opening 21a of the housing 21 in a fitting insertion completion state, where the fitting insertion is completed, and thus comes in contact with a counterpart terminal. Therefore, contact section 22b engages a mating terminal. It should be noted that an illustration of the counterpart terminal coming in contact with the contact section 22b is omitted.

The connection section 22c linearly extends from the press-fit section 22a of the contact 22 outside of the mating connector receiving opening 21a of the housing 21 to project in the direction of the backward B in the fitting insertion completion state, and is thus to be connected to a circuit board substantially perpendicular to the circuit board.

Moreover, the contact 22 includes a first narrow section (similar to the first narrow section 121 of the first embodiment), which is formed closer to the connection section 22c than the press-fit section 22a and is thinner than the press-fit section 22a, and a second narrow section (similar to the second narrow section 122 of the first embodiment), which is formed closer to the connection section 22c than the first narrow section and is further thinner than the first narrow section. A taper serving as a guide is formed on each of the contact section 22b and the connection section 22c. Further, a taper is also formed, as a guide, at a boundary part between the first narrow section and the second narrow section.

Furthermore, an alignment plate 30 is attached to the electrical connector 20 illustrated in FIGS. 8 and 9. The alignment plate 30 is a plate-like member having multiple through holes, and is used for allowing the connection sections 22c to be inserted into the through holes so that the tip ends of the connection sections 22c may be respectively aligned at predetermined positions when the connection sections 22c of the contacts 22 are connected to the circuit board.

Similar to the first embodiment, the contact fitting insertion guide structure and the electrical connector 20 of the second embodiment, even in the situation where a portion of the contact 22, which extends outside of the mating connector receiving opening 21a of the housing 21 from the press-fit section 22a and is connected to the circuit board, is elongated, displacement of the connection section 22c is suppressed with the contacts 22 press-fitted. Therefore, according to the second embodiment, the connection section 22c of the contact 22 is smoothly inserted into the through hole of the alignment plate 30 when the alignment plate 30 is attached.

Further, according to the second embodiment, the housing 21 has the wide section 11e and the contact support sections 11f, and both of them are wider than the second narrow section of the contact 22, similar to the contact fitting insertion guide structure and the electrical connector 10 of the first embodiment. Accordingly, when the contact 22 is inserted into the contact receiving passageways 11c from the side of the connection section 22c, the contact 22 does not come in contact with the inner wall of the contact receiving passageways 11c until the first narrow section of the contact 22 is supported by the contact support sections 11f of the housing 21. This prevents the inner wall of the contact receiving passageways 111c from being shaved or cracked by the contact 22 when the contact 22 is inserted, and prevents resin waste thus shaved from being adhered to the contact 22.

Furthermore, according to the contact fitting insertion guide structure and the electrical connector 20 of the second embodiment, the contact 22 is supported by two places of the securing sections 11d and the contact support sections 11f of the housing 21. Thus, when these two places can be molded with high precision at the time of molding the housing 21, there is no need to precisely form the entire contact receiving passageways 11c.

It should be noted that, in the embodiments described above, the description has been given as exemplifying the electrical connector. However, the contact insertion guide structure of the present invention is not limited to the electrical connector, and can be applied to various parts having a structure in which terminals are press-fit to an insulating material.

Moreover, in the embodiments described above, the descriptions have been given as exemplifying synthetic resin such as syndiotactic polystyrene (SPS), PBT or the like as a material forming the housing. However, the housing of the present invention is not limited to those, and may be formed of any material as far as it is an insulating material. Note, however, that the present invention is particularly effective in using resin such as SPS or the like having difficulty in forming through holes in accurate size and shape as compared with PBT or the like that is widely used as a material for forming a housing of the electrical connector.

What is claimed is:

1. A contact fitting insertion guide structure, comprising:
a contact having a mating portion for contacting a mating contact at one end, a terminal portion for connecting to a circuit board on an opposite end, and a press-fit section between the mating portion and the terminal portion; and
an insulative housing having a contact receiving passageway through which the contact is inserted, and a securing section which is formed in an inner wall of the contact receiving passageway and into which the press-fit section is received,
wherein the contact includes:
a first narrow section formed closer to the terminal portion than the press-fit section and thinner than the press-fit section; and
a second narrow section formed closer to the terminal portion than the first narrow section and further thinner than the first narrow section;
wherein the insulative housing comprises:
a wide section that is formed in the contact receiving passageway at a more downstream side in a direction where the contact is inserted than a position where the securing section is formed, the wide section having a larger width than that of the first narrow section of the contact; and
a contact support section that is formed in the contact receiving passageway at a more downstream side in the direction where the contact is inserted than a position where the wide section is formed, and the contact supporting section supporting the first narrow section of the contact.

2. The contact fitting insertion guide structure according to claim 1, wherein the contact has a taper formed at a boundary between the first narrow section and the second narrow section.

3. The contact fitting insertion guide structure according to claim 1, wherein the insulative housing has an inclined surface formed at a boundary part between the wide section and the contact support section of the housing.

4. The contact fitting insertion guide structure according to claim 1, wherein the press-fit section has a convex shape projecting in a direction crossing the direction where the contact is inserted.

5. An electrical connector, comprising:
a contact having a mating portion for contacting a mating contact at one end, a terminal portion to be connected to a circuit board at the other end of the terminal, and a press-fit section between the mating portion and the terminal portion; and
an insulative housing having a contact receiving passageway through which the contact is inserted, and a securing section which is formed in an inner wall of the contact receiving passageway and into which the press-fit section is received,
wherein the contact includes:
a first narrow section formed closer to the terminal portion than the press-fit section and thinner than the press-fit section; and
a second narrow section formed closer to the terminal portion than the first narrow section and further thinner than the first narrow section, and
the insulative housing includes:
a wide section that is formed in the contact receiving passageway at a more downstream side in a direction where the contact is inserted than a position where the securing section is formed, the wide section having a larger width than that of the first narrow section of the contact; and
a contact support section that is formed in the contact receiving passageway at a more downstream side in the direction where the contact is inserted than a position where the wide section is formed, and the contact supporting section supporting the first narrow section of the contact.

6. The electrical connector according to claim 5, wherein the contact has a taper formed at a boundary between the first narrow section and the second narrow section.

7. The electrical connector according to claim 5, wherein the insulative housing has an inclined surface formed at a boundary between the wide section and the contact support section.

8. The electrical connector according to claim 5, wherein the press-fit section has a convex shape projecting in a direction crossing the direction where the contact is inserted.
